(19) United States
(12) Patent Application Publication
(10) Pub. No.: US 2014/0133559 A1
(43) Pub. Date: May 15, 2014

(54) METHOD FOR ENCODING IMAGE INFORMATION AND METHOD FOR DECODING SAME

(71) Applicants: Hui Yong Kim, Daejeon-si (KR); Jin Ho Lee, Daejeon-si (KR); Sung Chang Lim, Daejeon-si (KR); Jin Soo Choi, Daejeon-si (KR); Jin Woong Kim, Daejeon-si (KR)

(72) Inventors: Hui Yong Kim, Daejeon-si (KR); Jin Ho Lee, Daejeon-si (KR); Sung Chang Lim, Daejeon-si (KR); Jin Soo Choi, Daejeon-si (KR); Jin Woong Kim, Daejeon-si (KR)

(73) Assignee: ELECTRONICS AND TELECOMMUNICATIONS RESEARCH INSTITUTE, Daejeon (KR)

(21) Appl. No.: 14/130,716

(22) PCT Filed: Jul. 2, 2012
(86) PCT No.: PCT/KR2012/005252

§ 371 Date: Jan. 3, 2014

(30) Foreign Application Priority Data
Jul. 5, 2011 (KR) 10-2011-0066402
Jul. 2, 2012 (KR) 10-2012-0071616

(51) Int. Cl. H04N 19/11; H04N 19/174; H04N 19/137; H04N 19/50

(52) U.S. Cl. CPC H04N 19/00042; H04N 19/00569; H04N 19/00272; H04N 19/00145
USPC 375/240.12

(57) ABSTRACT

The present invention relates to a method for encoding image information, to a method for decoding same, and to an apparatus using the methods. The method for decoding the image information according to one embodiment of the present invention comprises the steps of: dividing a prediction area into a first prediction area and a second prediction area according to an intra-prediction mode; performing intra prediction on, and restoration of, the first prediction area; and performing prediction on, and restoration of, the second prediction area. In the step of performing prediction on, and restoration of, the second prediction area, intra-prediction on the second prediction area can be performed with reference to a reference sample for the first prediction area or with reference to a predetermined sample in the restored first prediction area.

### TECHNICAL FIELD

The present invention relates to a video information compression technique, and more particularly, to an intra-prediction mode dependent image segmentation method and apparatus.

### BACKGROUND ART

As a high definition (HD) broadcast service is extended not only domestically but also globally, many users become accustomed to images having high resolution and high definition and thus many organizations accelerate development of next-generation image apparatuses. Furthermore, an increasing attention to ultra high definition (UHD) more than four times HD requires a compression technique for images having higher resolution and higher picture quality.

Image compression techniques include inter prediction for predicting pixel values included in a current picture from a picture temporally before and/or after the current picture, intra prediction for predicting the pixel values included in the current picture using information on pixels in the current picture, weighted prediction for preventing deterioration of definition due to an illumination variation, entropy coding for allocating a short code to a symbol of high frequency and allocating a long code to a symbol of low frequency, etc. Particularly, when a current block is predicted in a skip mode, a predicted block is generated using only a value predicted from a previously coded region and additional motion information or a residual signal is not transmitted from an encoder to a decoder. The above-mentioned image compression techniques can efficiently compress video data.

Intra prediction from among the image compression techniques uses various intra prediction modes. Pixel values of the current block can be predicted using different reference samples depending on prediction modes. Accordingly, it is possible to consider a method for obtaining optimized compression efficiently by adaptively changing a prediction scheme according to prediction modes, that is, reference samples.

### SUMMARY OF INVENTION

### Technical Problem

An object of the present invention is to provide a method for increasing intra coding efficiency and reducing complexity of a video information processing procedure.

Another object of the present invention is to provide a method for segmenting a prediction unit (PU) and a transform unit (TU) according to intra prediction mode.

Another object of the present invention is to provide a method for solving a complexity problem generated when a PU and a TU are segmented irrespective of prediction mode.

Another object of the present invention is to provide a method for determining prediction modes for PUs segmented according to prediction mode.

Another object of the present invention is to provide a method for segmenting a PU and a TU to improve intra prediction performance and reduce complexity in determining an optimized PU segmentation structure and an optimized TU segmentation structure.

### Technical Solution

(1) In accordance with one aspect of the present invention, a method for decoding video information includes: segmenting a prediction unit (PU) into a first PU and a second PU according to an intra prediction mode; performing intra prediction and reconstruction of the first PU; and performing prediction and reconstruction of the second PU, wherein, in the prediction and reconstruction of the second PU, intra prediction of the second PU is performed with reference to a reference sample for the first PU or a predetermined sample in the reconstructed first PU.

(2) Information about the intra prediction mode may be received from an encoder and, in the segmentation of the PU, a region in which a residual signal that exceeds a reference value is present may be set as the second PU when the intra prediction mode is used.

(3) Information about the intra prediction mode may be received from an encoder and the second PU may be the farthest block in a current block from a reference sample of the intra prediction mode.

(4) Information about the intra prediction mode may be received from an encoder, and the first PU and the second PU may be predetermined for each intra prediction mode.

(5) The performing of intra prediction and reconstruction of the second PU may include generating a residual signal on the basis of a transform coefficient of a transform unit (TU) corresponding to the second PU and combining a prediction result with respect to the second PU with the generated residual signal to generate a reconstructed signal.

(6) The second PU may be further segmented into a plurality of PUs, and the plurality of PUs may be intra-predicted with reference to the reference sample for the first PU or predetermined samples in other reconstructed PUs.

(7) A prediction mode applied to the second PU may be selected from a prediction mode applied to the first PU and prediction modes having angles similar to the prediction mode applied to the first PU.

(8) Intra prediction of the second PU may be performed with reference to a sample in the reconstructed first PU.

(9) A prediction mode applied to the second PU may be selected from candidate prediction modes for the first PU.

(10) A prediction mode applied to the second PU may be selected from a prediction mode applied to a block adjacent to the second PU and prediction modes having angles similar to the prediction mode applied to the block adjacent to the second PU.

(11) In accordance with another aspect of the present invention, a method for encoding video information includes: segmenting a prediction unit (PU) into a first PU and a second PU according to an intra prediction mode; performing intra prediction and reconstruction of the first PU; performing prediction and reconstruction of the second PU; and transmitting information about a prediction mode of a current block, wherein, in the prediction and reconstruction of the second PU, intra prediction of the second PU is performed with reference to a reference sample for the first PU or a predetermined sample in the reconstructed first PU.

(12) In the segmentation of the PU, a region in which a residual signal that exceeds a reference value is present may be set as the second PU when the intra prediction mode is used.

(13) The second PU may be the farthest block in the current block from a reference sample of the intra prediction mode.

(14) The performing of intra prediction and reconstruction of the second PU may include generating a residual signal on the basis of a transform coefficient of a TU corresponding to the second PU and combining a prediction result with respect to the second PU with the generated residual signal to generate a reconstructed signal.

(15) The TU may be a block having the same size as the first PU and the second PU or a square or a non-square block obtained by segmenting the first PU or the second PU.

(16) In the segmentation of the PU into the first PU and the second PU, the second PU may be further segmented into a plurality of PUs, and intra prediction of the plurality of PUs may be performed with reference to the reference sample for the first PU or predetermined samples in other reconstructed PUs.

(17) A prediction mode applied to the second PU may be selected from a prediction mode applied to the first PU and prediction modes having angles similar to the prediction mode applied to the first PU.

(18) A prediction mode applied to the second PU may be selected from a prediction mode of a block adjacent to the second PU and prediction modes having angles similar to the prediction mode of the block adjacent to the second PU.

### Advantageous Effects

The present invention can increase intra coding efficiency and reduce complexity of a video information processing procedure.

The present invention can solve a complexity problem generated when a PU and a TU are segmented irrespective of prediction mode.

Furthermore, the present invention can perform prediction and transform on the basis of an optimized PU segmentation structure and an optimized TU segmentation structure by segmenting a PU and a TU according to intra prediction mode.

In addition, the present invention can improve intra prediction performance by applying optimized prediction modes to PUs and TUs segmented according to intra prediction mode.

### DESCRIPTION OF DRAWINGS

FIG. 1 is a block diagram illustrating a configuration of a video encoding apparatus according to an embodiment of the present invention;

FIG. 2 is a block diagram illustrating a configuration of a video decoding apparatus according to an embodiment of the present invention;

FIG. 3 illustrates intra prediction modes;

FIG. 4 illustrates samples that can be referred to by a current block in an intra prediction mode;

FIG. 5 illustrates residual signal distributions according to directional prediction.

FIG. 6 illustrates exemplary first and second prediction units predetermined according to intra prediction mode in a system to which the present invention is applied;

FIG. 7 is a flowchart illustrating an exemplary intra prediction method in the system to which the present invention is applied;

FIG. 8 is a flowchart illustrating an operation of an encoder that performs the intra prediction method in the system to which the present invention is applied;

FIG. 9 is a flowchart illustrating an operation of a decoder that performs the intra prediction method in the system to which the present invention is applied;

FIG. 10 illustrates exemplary segmentation structures of a coding unit (CU), a prediction unit (PU) and a transform unit (TU);

FIG. 11 illustrates examples of segmenting a current block (target coding block) into two PUs according to prediction mode in the system to which the present invention is applied;

FIG. 12 illustrates other examples of segmenting the current block (target coding block) into two PUs according to prediction mode in the system to which the present invention is applied;

FIG. 13 illustrates examples of segmenting the current block (target coding block) into three PUs according to prediction mode in the system to which the present invention is applied;

FIG. 14 illustrates examples of transform of a non-square TU in the system to which the present invention is applied;

FIG. 15 illustrates examples of predicting a lower priority PU using a reconstructed sample of a higher priority PU on the basis of correlation between the higher priority PU and the lower priority PU in a current block in the system to which the present invention is applied; and

FIG. 16 illustrates examples of determining a prediction mode of a current PU in the system to which the present invention is applied.

### MODE FOR INVENTION

The above and other aspects of the present invention will be described in detail through preferred embodiments with reference to the accompanying drawings. The same reference numbers will be used throughout this specification to refer to the same or like parts. In the following description of the present invention, a detailed description of known functions and configurations incorporated herein will be omitted when it may obscure the subject matter of the present invention.

When it is said that an element is “coupled” or “connected” to another element, this means that the element may be directly coupled or connected to the other element, or another element may be present between the two elements. Through the specification, when it is said that some part “includes” a specific element, this means that the part may further include other elements, not excluding them, unless otherwise mentioned.

While the terms “first”, “second”, etc. can be used to describe various elements, they do not limit the elements and are used to distinguish an element from another element. For example, a first element may be referred to as a second element and the second element may be referred to as the first element without departing from the scope of the present invention.

Units described in embodiments of the present invention are independently illustrated to represent different characteristic functions and they are not configured in the form of separate hardware components or a software component. That is, the units are respectively arranged for convenience of description, and at least two of them may be combined into one unit or one unit may be divided into a plurality of units. Embodiments of combining units and embodiments of dividing a unit are included in the scope of the present invention.

In addition, some elements may be selective elements for improving performance rather than essential elements for performing essential functions of the present invention. The present invention may comprise only essential units necessary to implement the spirit of the present invention or a configuration including only essential elements other than selective elements used to improve performance.

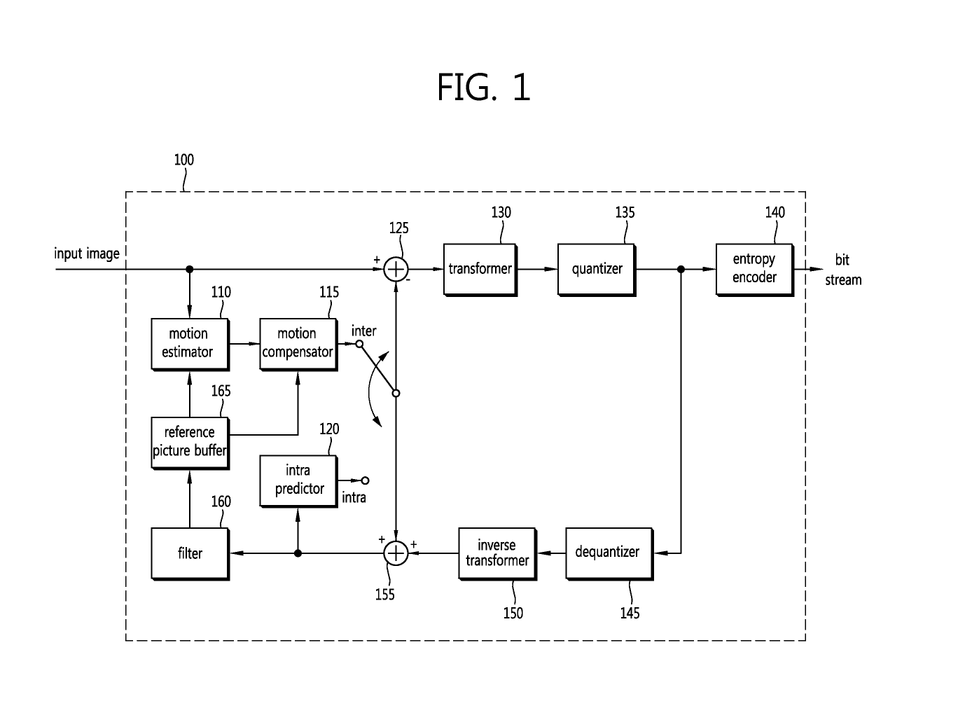

FIG. 1 is a block diagram illustrating a configuration of a video encoding apparatus according to an embodiment of the present invention.

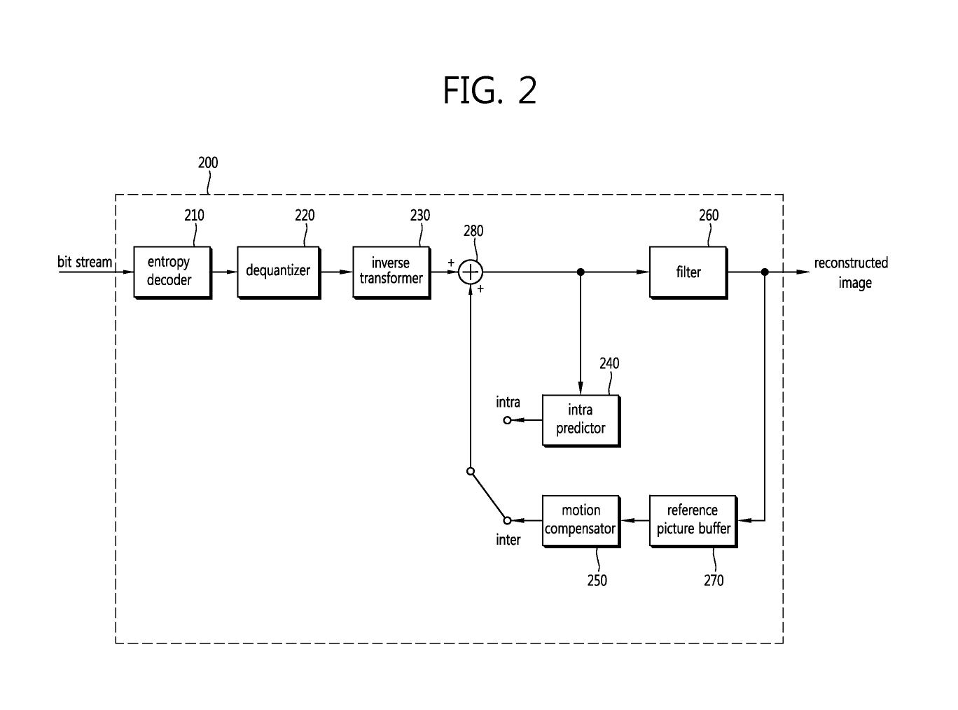

Referring to FIG. 2, the video encoding apparatus 100 includes a motion estimator 110, a motion compensator 115, an intra predictor 120, a subtractor 125, a transformer 130, a quantizer 135, an entropy encoder 140, a dequantizer 145, an inverse transformer 150, an adder 155, a filter 160, and a reference picture buffer 165.

The video encoding apparatus 100 may encode an input image in an intra mode or an inter mode and output a bit stream. Prediction may be performed in the intra predictor 120 in the intra mode and may be carried out in the motion estimator 110 and the motion compensator 115 in the inter mode. The video encoding apparatus 100 may generate a prediction block for an input block of the input image, and then encode a difference between the input block and the prediction block.

In the intra mode, the intra predictor 120 may generate the prediction block by performing spatial prediction using pixel values of previously coded blocks adjacent to a current block.

In the inter mode, the motion estimator 110 may obtain a motion vector by detecting a region best matched with the input block from reference images stored in the reference picture buffer 165. The motion compensator 115 may generate the prediction block by performing motion compensation using the motion vector and the reference images stored in the reference picture buffer 165.

The subtractor 125 may generate a residual block using a difference between the input block and the generated prediction block. The transformer 130 may transform the residual block to output a transform coefficient. A residual signal may mean a difference between a source signal and a predicted signal, a signal obtained by transforming the difference between the source signal and the predicted signal, or a signal obtained by transforming and quantizing the difference between the source signal and the predicted signal. The residual signal may be referred to as a residual block in the unit of block.

The quantizer 135 may output a quantized coefficient obtained by quantizing the transform coefficient according to a quantization parameter.

The entropy encoder 140 may entropy-encode symbols corresponding to values generated by the quantizer 135 or encoding parameters generated during an encoding process according to probability distribution to output the bit stream.

Entropy encoding can improve video encoding performance by allocating a small number of bits to a symbol having high generation probability and allocating a large number of bits to a symbol having low generation probability.

Encoding methods such as context-adaptive variable length coding (CAVLC), context-adaptive binary arithmetic coding (CABAC), etc. may be used for entropy encoding. For example, the entropy encoder 140 may perform entropy encoding using a variable length coding/code (VLC) table. The entropy encoder 140 may derive a binarization method of a target symbol and a probability model of the target symbol/a bin and perform entropy encoding using the derived binarization method or the probability model.

The quantized coefficient may be inversely quantized by the dequantizer 145 and inversely transformed by the inverse transformer 150. The inversely transformed coefficient is generated as a reconstructed residual block, and the adder 155 may generate a reconstructed block using the prediction block and the reconstructed residual block.

The filter 160 may apply at least one of a deblocking filter, a sample adaptive offset (SAO), and an adaptive loop filter (ALF) to the reconstructed block or a reconstructed picture. The reconstructed block output from the filter 160 may be stored in the reference picture buffer 165.

FIG. 2 is a block diagram illustrating a configuration of a video decoding apparatus 200 according to an embodiment of the present invention.

Referring to FIG. 2, the video decoding apparatus 200 may include an entropy decoder 210, a dequantizer 220, an inverse transformer 230, an intra predictor 240, a motion compensator 250, a filter 260, a reference picture buffer 270, and an adder 280.

The video decoding apparatus 200 may receive a bit stream output from an encoder and decode the bit stream in the intra mode or inter mode to output a reconstructed image. Prediction may be performed in the intra predictor 240 in the intra mode whereas prediction may be carried out in the motion compensator 250 in the inter mode. The video decoding apparatus 20 may obtain a reconstructed residual block from the received bit stream, generate a prediction block and sum the reconstructed residual block and the prediction block to generate a reconfigured block, that is, a reconstructed block.

The entropy decoder 210 may entropy-decode the input bit stream according to probability distribution to generate symbols in the form of a quantized coefficient. The entropy decoding method may correspond to the above-described entropy encoding method.

The quantized coefficient may be inversely quantized by the dequantizer 220 and inversely transformed by the inverse transformer 230, and thus a reconstructed residual block may be generated.

In the intra mode, the intra predictor 240 may generate a prediction block by performing spatial prediction using pixel values of previously decoded blocks around a current block. In the inter mode, the motion compensator 250 may generate the prediction block by performing motion compensation using a motion vector and reference images stored in the reference picture buffer 270.

The adder 280 may generate a reconstructed block on the basis of the reconstructed residual block and the prediction block. The filter 260 may apply at least one of a deblocking filter, SAO and ALF to the reconstructed block. The filter 260 outputs the reconstructed image. The reconstructed image may be stored in the reference picture buffer 270 and used for inter-picture prediction.

In the intra prediction mode, directional prediction or nondirectional prediction is performed using one or more reconstructed reference samples.

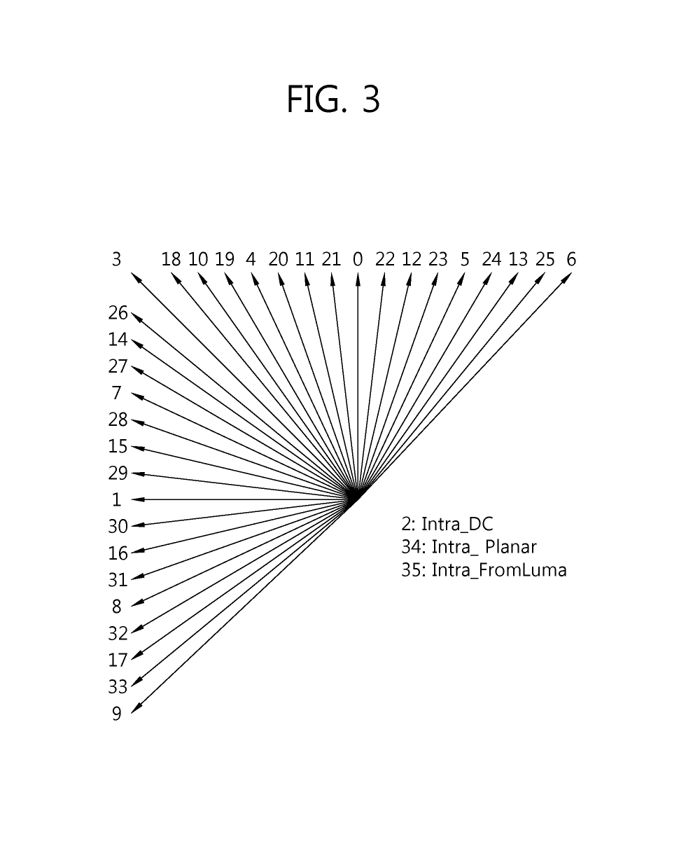

FIG. 3 illustrates intra prediction modes. It can be seen from FIG. 3 that 0, 1 and 3 to 33 modes, exclusive of a DC mode Intra_DC, a planar mode Intra_Planar mode and a mode Intra_FromLuma that applies luma mode to chroma, are defined according to direction.

The number of modes that can be used to predict a current block from among the prediction modes shown in FIG. 3 may be determined by the size of the current block.

Table 1 shows the number of available prediction modes according to the number of the current block.

TABLE 1

| Size of current block | Number of intra prediction modes |
|---|---|
| (log2Trafosize) | (INTRAPREDMODENUM) |
| 2 (4 × 4) | 18 |
| 3 (8 × 8) | 35 |
| 4 (16 × 16) | 35 |
| 5 (32 × 32) | 35 |
| 6 (64 × 64) | 4 |

Here, a target prediction block, that is, the current block may be a rectangular block having a size of 2×8, 4×8, 2×16, 4×16 or 8×16 as well as a square block having a size of 2×2, 4×4, 8×8, 16×16, 32×32 or 64×64 shown in Table 1.

The size of the target prediction block may correspond to the size of at least one of a coding unit (CU), a prediction unit (PU) and a transform unit (TU).

In intra prediction, reference sample information can be used according to modes as shown in FIG. 3.

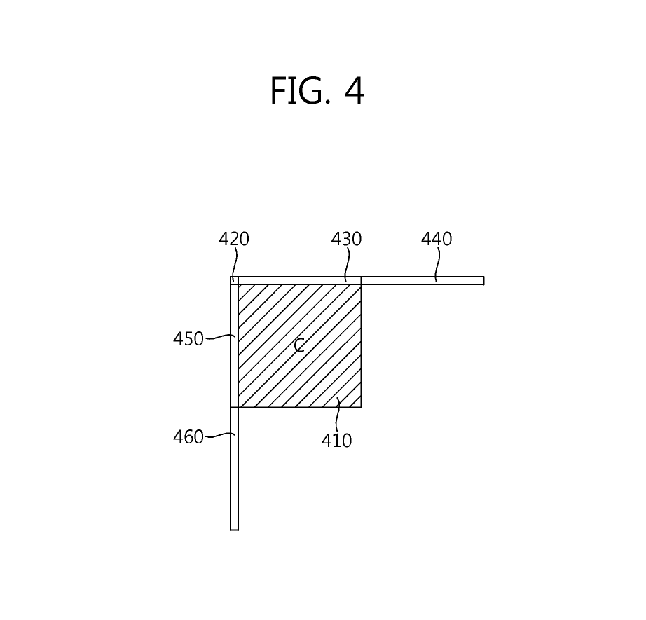

FIG. 4 illustrates samples that can be referred to by the current block in the intra prediction mode. Referring to FIG. 4, when intra prediction is applied to the current block (C) 410, a reference sample selected according to prediction mode from reconstructed reference samples adjacent to the current block 410, that is, an above-left reference sample 420, an above reference sample 430, an above-right reference sample 440, a left reference sample 450, and a below-left reference sample 460, can be used to predict the current block 410.

For example, if the prediction mode of the current block 410 is a vertical mode (mod=0) shown in FIG. 3, the above reference sample 430 of the current block 410 can be used. If the prediction mode of the current block 410 is a horizontal mode (mod=1) shown in FIG. 3, the left reference sample 450 of the current block C can be used.

When the prediction mode of the current block 410 is mode 13 shown in FIG. 3, the above reference sample 430 or the above-right reference sample 440 of the current block 410 can be used. When the prediction mode of the current block 410 is mode 7 shown in FIG. 3, the left reference sample 450 or the below-left reference sample 460 of the current block 410 can be used.

As described above, in directional prediction (intra prediction modes, 0, 1, 3 to 33) used for intra prediction, prediction based pixel values (reference sample values) are directly used as prediction values according to prediction direction, that is, prediction mode, or the average of the prediction based pixel values is used as a prediction value. Otherwise, it is possible to use residual quadtree (RQT) that segments a TU separately from PU segmentation and then signals a TU segmentation structure. In this case, however, it is impossible to use characteristic that a residual signal distribution varies with intra prediction mode. Accordingly, improvement of encoding efficient is limited and complexity of an encoder increases when determining an optimized TU segmentation structure.

Specifically, prediction accuracy of directional prediction used to encode/decode video information decreases as a distance from a reference sample increases.

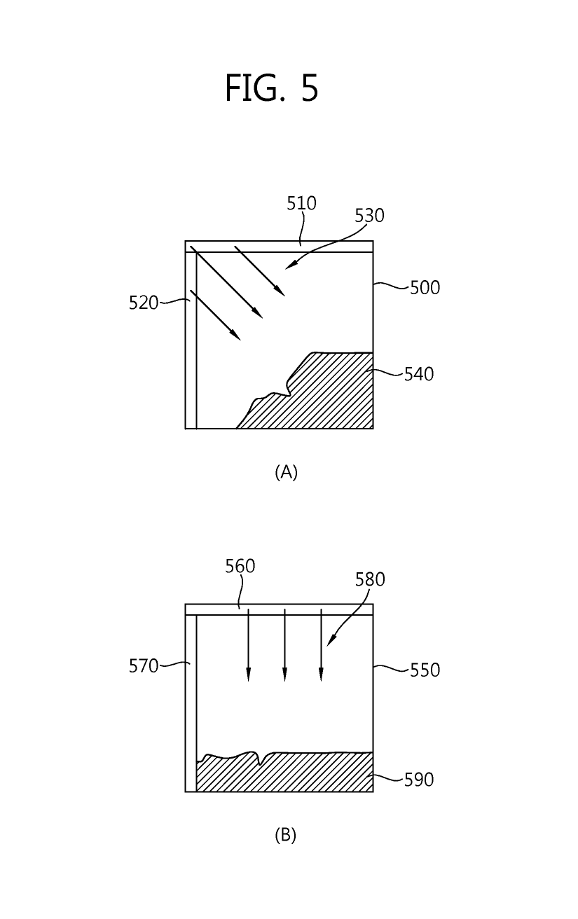

FIG. 5 illustrates residual signal distributions according to directional prediction.

FIG. 5(A) illustrates a residual signal distribution when diagonal prediction is performed in a direction from the above left of a current block 500 corresponding to a target prediction block to the below right thereof. In FIG. 5(A), the intra prediction mode is applied to the current block 500 and prediction 530 is performed in the below right direction using reference samples 510 and 520. As shown in FIG. 5(A), residual signals 540 are distributed mostly in the below right part of the current block 500 at a distance from the reference samples.

FIG. 5(B) illustrates a residual signal distribution when prediction is performed in the vertical direction. In FIG. 5(B), the intra prediction mode is applied to a current block 550 corresponding to a target prediction block and prediction 580 is performed in the vertical direction using an above reference sample 560 from among reference samples 560 and 570. As shown in FIG. 5(B), residual signals 590 are distributed at the bottom of the current block 550, at a distance from the above reference sample 560.

As shown in FIGS. 5(A) and 5(B), a residual signal size increases as a distance between a residual signal and a reference sample increases, in general. Furthermore, a residual signal distribution depends on prediction mode.

As described above, prediction accuracy of directional prediction decreases as a distance from a reference sample increases. Accordingly, considering that the residual signal size and the number of distributed residual signals increase as the distance from the reference sample increases, it is possible to improve prediction efficiency by using a reconstructed sample closer to a block estimated as a region in which many residual signals are distributed as a reference sample according to intra prediction direction.

In this case, the region in which many residual signals are distributed can be determined according to intra prediction mode. When the residual signal distribution region is determined according to intra prediction mode, it is possible to reduce overhead of signaling necessary to encode information about unit segmentation and to minimize complexity required to determine a unit segmentation structure.

In the specification, a unit estimated as a region in which many residual signals are distributed is referred to as ‘second PU’ and a unit other than the second PU in the current block, that is, a unit estimated as a region in which many residual signals are not distributed is referred to as ‘first PU’ for convenience of description.

In this case, a region in which residual signals having sizes greater than a predetermined value are distributed can be set as the second PU. Furthermore, a region predetermined according to prediction mode may be set as the second PU. For example, a region farthest away from a reference sample within the current block in each prediction mode can be set as the PU.

Here, the second PU may have the same size as that of a TU, as illustrated in the following figures.

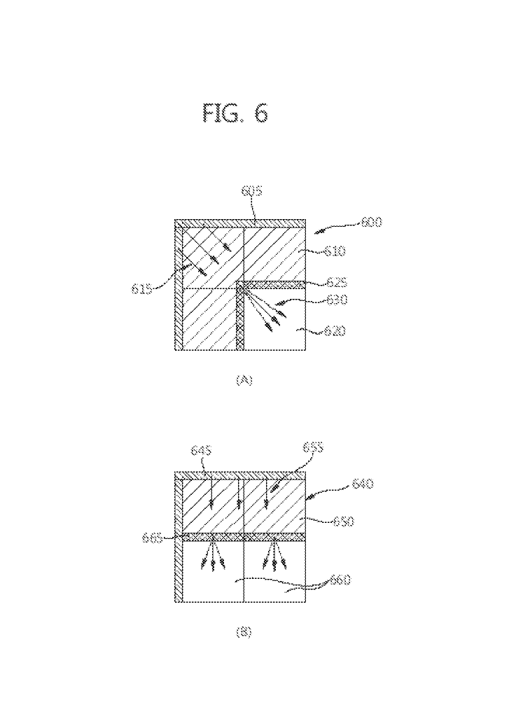

FIG. 6 illustrates exemplary first and second PUs predetermined according to intra prediction mode in a system to which the present invention is applied. In FIGS. 6(A) and 6(B), a TU is set such that it has a size corresponding to a quarter of a target prediction block (current block).

Referring to FIG. 6(A), intra prediction is performed on a first PU 610 of a current block 600 using a reconstructed reference sample 605 around the current block 600. In the example of FIG. 6(A), a prediction mode 615 in the below right direction is applied to the first PU 610 of the current block 600.

In FIG. 6(A), it is possible to improve coding efficiency of a second PU 620 estimated to be a region in which many residual signals are generated by using a sample 625 of the reconstructed first PU for prediction of the second PU 620 after prediction and transform/reconstruction of the first PU 610. A prediction mode 630 applied to the second PU 620 may be determined upon reconstruction of the first PU 610.

Referring to FIG. 6(B), intra prediction is performed on a first PU 650 of a current block 640 using a reconstructed reference sample 645 around the current block 640. In the example of FIG. 6(B), a vertical prediction mode 655 is applied to the first PU 640 of the current block 640.

In FIG. 6(B), it is possible to improve coding efficiency of a second PU 660 estimated to be a region in which many residual signals are generated by using a sample 665 of the reconstructed first PU for prediction of the second PU 660 after prediction and transform/reconstruction of the first PU 650. A prediction mode 670 applied to the second PU 660 may be determined after reconstruction of the first PU 650.

When a PU is further segmented in addition to first and second PUs, the process of performing prediction on the second PU using a sample of the reconstructed first PU after prediction/transform/reconstruction of the first PU is repeated. For example, if the second PU is segmented into a third PU or the first PU is segmented into second and third PUs, the third PU can be predicted using a sample of the reconstructed second PU.

In the specification, ‘PU’ refers to a region in which a pixel value is predicted according to various intra prediction modes and ‘TU’ refers to a region including all or part of the PU and having the same prediction mode as that of the PU including the TU. In the TU, a sample value is reconstructed through transcoding.

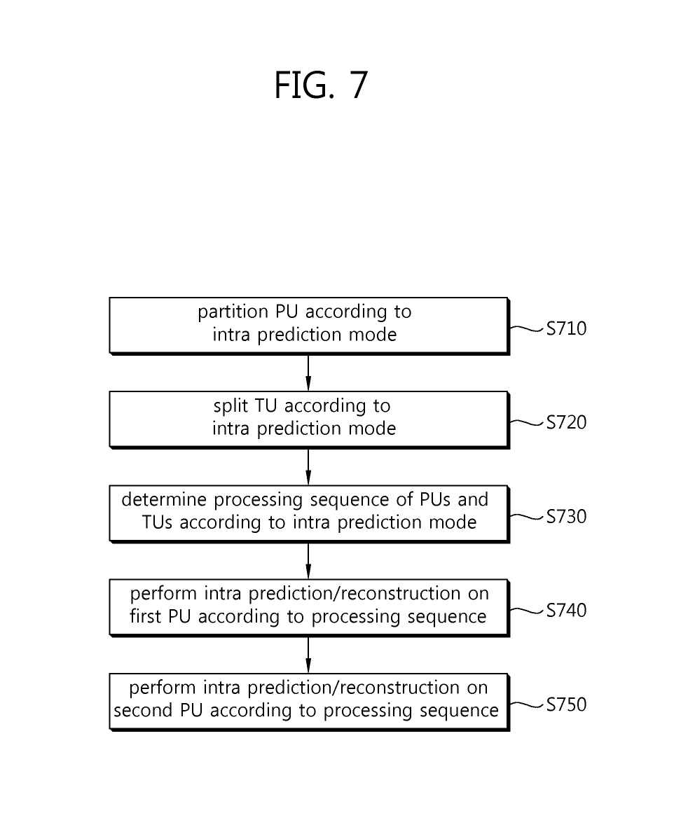

FIG. 7 is a flowchart illustrating an exemplary intra prediction method in the system to which the present invention is applied. The intra prediction method shown in FIG. 7 may be performed in an encoder or a decoder.

Referring to FIG. 7, a PU is partitioned into two or more units in a current block according to intra prediction mode (S710).

A TU is split into two or more units according to intra prediction mode (S720).

A processing sequence of the PU and TU is determined according to intra prediction mode (S730).

Intra prediction/reconstruction is performed on a first PU according to the determined processing sequence (S740).

After reconstruction of the first PU, intra prediction/reconstruction is performed on a second PU according to the processing sequence (S750).

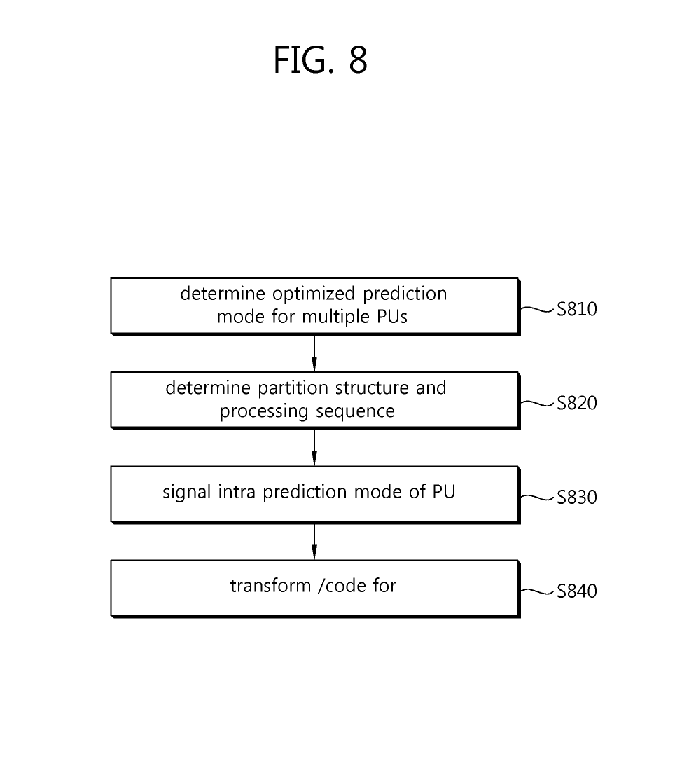

FIG. 8 is a flowchart illustrating an operation of an encoder that performs the above-described intra prediction method in the system to which the present invention is applied.

Referring to FIG. 8, the encoder determines an optimized prediction mode for a plurality of PUs (S810). A method of determining the optimized prediction mode will now be described for an n-th PU predetermined for each prediction mode in a current block. Prediction and transform/reconstruction are performed according to a TU structure and transform/reconstruction sequence predetermined for each prediction mode. A prediction error and/or the quantity of prediction bits for the n-th PU are calculated, and an optimized intra prediction mode for the n-th PU may be determined on the basis of the calculated prediction error and/or the quantity of prediction bits.

A partitioning (splitting) structure and processing sequence for the current block are determined (S820). Partitioning structures of PUs and TUs of the current block and a processing sequence of the PUs and TUs are determined according to the optimized intra prediction mode, determined in step S810, for the first (n=1) PU of the current block. It is possible to determine the number, N, of all PUs with the partitioning structures of the PUs and TUs of the current block.

Prediction modes of the PUs are signaled (S830). The optimized intra prediction mode of the n-th PU is signaled. Prediction mode candidate(s) for prediction of the n-th PU can be determined using prediction modes available for prediction of PUs following the first PU (n>1) and prediction modes of units adjacent to the n-th PU from among reconstructed units of the PUs following the first PU (n>1).

Transform and coding is performed on the PUs (S840). Transform and coding can be performed on the n-th PU by coding a transform coefficient of each TU belonging to the n-th PU for a prediction error signal according to the optimized intra prediction mode of the n-th PU according to the partitioning structure and processing sequence of the TUs, determined in step S820, for each TU included in the n-th PU.

When the aforementioned steps have been performed on all PUs (n==N), the procedure is ended. If the above-described steps have not been performed on all the PUs (n<N), steps following step S810 may be re-performed on the next PU (i.e. PU corresponding to n=n+1).

Accordingly, the procedure of FIG. 8 can be performed in the order of the first, second and third PUs. Here, step S820 for the first PU may not be performed for the second and following PUs.

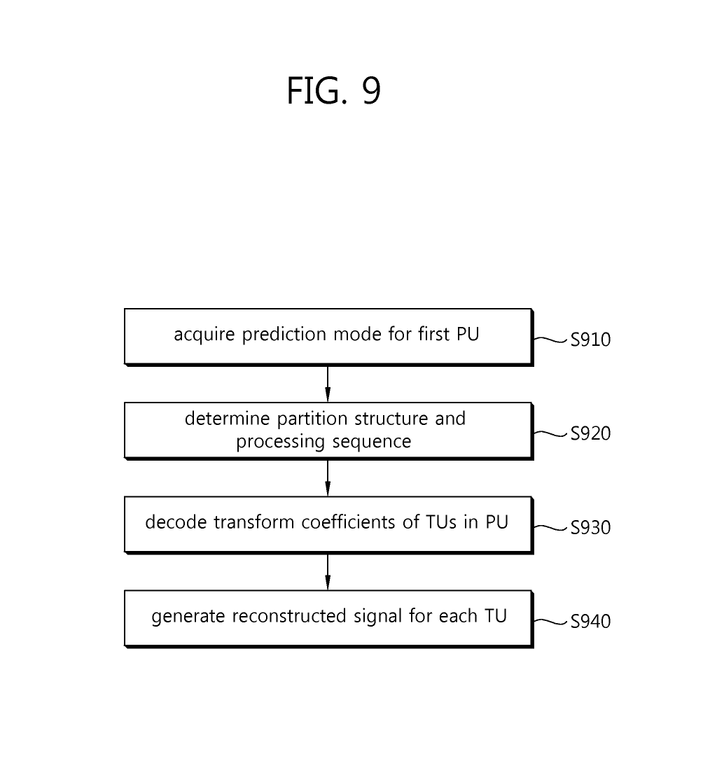

FIG. 9 is a flowchart illustrating an operation of a decoder that performs the intra prediction method in the system to which the present invention is applied.

Referring to FIG. 9, the decoder obtains a prediction mode for the first PU by parsing a bit stream received from the encoder (S910).

The decoder determines a partitioning structure and processing sequence for the current block (S920).

The decoder determines partitioning structures and processing sequences of PUs and TUs for the current block (target decoding block) according to the prediction mode obtained in step S910. The decoder may determine the number N of all PUs with the partitioning structures of the PUs and TUs.

The decoder decodes transform coefficients for respective TUs in PUs (S930). For example, if the current block includes N PUs, the decoder can decode transform coefficients of respective TUs included in the N PUs by parsing the bit stream. For the second and following PUs, prediction mode candidate(s) for prediction of the n-th PU can be determined using prediction modes available for prediction of the first PU and prediction modes of units adjacent to the n-th PU from among reconstructed PUs other than the first PU.

Subsequently, reconstructed signals for the respective TUs are generated (S940). As to the n-th PU, the decoder inversely transforms the transform coefficients of TUs included in the n-th PU to reconstruct residual signals according to the partitioning structure and processing sequence of the TUs, determined in step S910. The decoder can reconstruct the n-th PU by summing the reconstructed residual signals and a result of prediction performed according to the prediction mode for the n-th PU to generate reconstructed signals for the TUs.

When the aforementioned steps have been performed on all PUs (n==N), the procedure is ended. If the above-described steps have not been performed on all the PUs (n<N), steps following step S910 may be re-performed on the next PU (i.e. PU corresponding to n=n+1).

Accordingly, the procedure of FIG. 9 can be performed in the order of the first, second and third PUs. Here, step S930 for the first PU may not be performed for the second and following PUs.

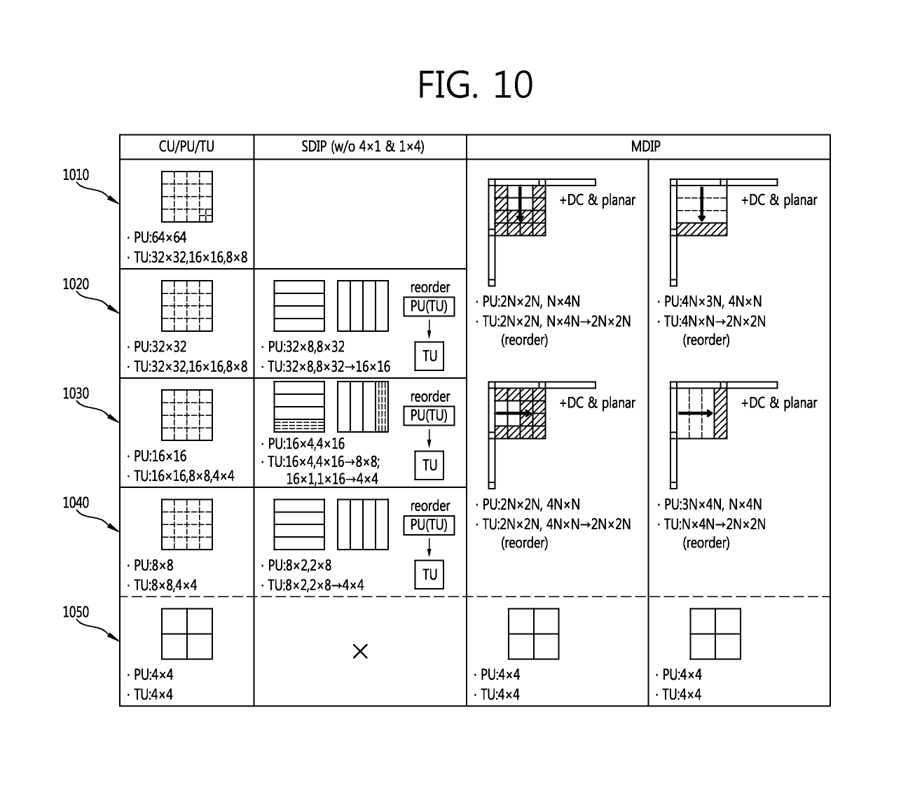

FIG. 10 illustrates exemplary partitioning structures of a CU, a PU and a TU.

FIG. 10 shows partitioning examples of a 64×64 CU 1010, a 32×32 CU 1020, 16×16 CU 1030 and an 8×8 CU 1040.

PU and TU partitioning structures for each CU size can be confirmed from FIG. 10.

Furthermore, a short distance intra prediction (SDIP) unit can be defined for a predetermined CU size. SDIP adds rectangle and line partition structures to the conventional partitioning structure. In the SDIP, a CU can be divided into non-square PUs, for example, PUs having a height (or width) identical to the CU and a width (or height) corresponding to a half or quarter of the CU, instead of square PUs.

Moreover, mode dependent intra prediction (MDIP) may be performed, as shown in FIG. 10. In the MDIP, a partitioning structure depends on prediction mode as described above. FIG. 10 illustrates a method of using an above reference sample and a method of using a left reference sample from among methods of determining a partitioning structure based on an intra prediction mode or additionally partitioning (splitting) a CU. As shown in FIG. 10, the current block may be predicted using a nondirectional intra prediction mode such as a DC mode and a planar mode in addition to directional prediction mode.

Referring to FIG. 10, in normal intra prediction and SDIP other than MDIP, PU and TU partitioning (splitting) schemes may vary according to current block size. When MDIP is applied, PU and TU partitioning structures are not changed according to block size except a minimum PU/a minimum TU that cannot be further partitioned (split). In MDIP, a partitioning structure may vary according to prediction mode.

For PUs in a CU, a considerably large number of TU partitioning structures based on a quadtree structure may be proposed. When an optimized transform structure is selected upon comparison of all encoding results for the above various partitioning structures, coding complexity increases. Furthermore, signaling overhead increases when the various TU partitioning structures are signaled.

Accordingly, when partition (splitting) of the current block is determined based on intra prediction mode, as proposed by the present invention, the number of PU partitioning structure and the number of TU partitioning structure are fixed to 1 or 2 and optimized according to prediction mode, and thus coding performance increases while coding complexity decreases. Furthermore, the number of prediction mode candidate sets can be reduced according to partitioning structure for each prediction mode to result in a decrease in the coding complexity.

TU segmentation depending on prediction mode according to the present invention will now be described in detail with reference to the attached drawings.

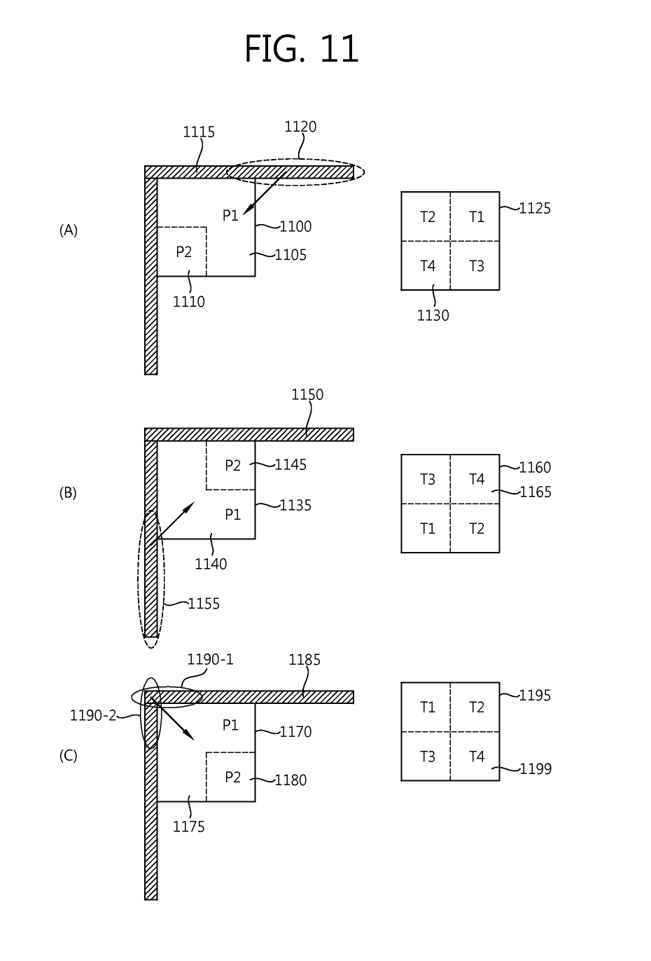

FIG. 11 illustrates examples of partitioning a current block (target coding block) into two PUs according to prediction mode in the system to which the present invention is applied. In FIG. 11, a CU is partitioned into square PUs.

In FIGS. 11(A), 11(B) and 11(C), first PUs P1 obtained by partitioning CUs 1100, 1135 and 1170 may be intra-predicted on the basis of decoded samples 1115, 1150 and 1185 adjacent thereto. Coding of partitioned PUs may be performed in such a manner that prediction/reconstruction of the first PUs P1 is performed and then prediction/reconstruction of second PUs P2 is carried out. Accordingly, when the second PUs P2 having a lot of residual signals are predicted, prediction efficiency can be improved by using samples of the reconstructed first PUs P1 as reference samples.

Referring to FIG. 11(A), the first PU 1105 of the current block 1100 may be predicted on the basis of a reference sample capable of obtaining high compression efficiency. In the example shown in FIG. 11(A), if an above/above-right sample 1120 of the current block 1100 is a reference sample that can obtain the highest compression efficiency for the first PU 1105, the first PU 1105 can be predicted using the reference sample 1120. For example, prediction modes {20, 11, 21, 0, 22, 12, 23, 5, 24, 13, 25, 6} shown in FIG. 3 can correspond to the reference sample 1120. Prediction of the second PU 1110 may be performed using a sample of the reconstructed first PU 1105.

Referring to FIG. 11(B), the first PU 1140 of the current block 1135 may be predicted on the basis of a reference sample capable of obtaining high compression efficiency. In the example shown in FIG. 11(B), if a left/below-left sample 1155 of the current block 1135 is a reference sample that can obtain the highest compression efficiency for the first PU 1140, the first PU 1140 can be predicted using the reference sample 1155. For example, prediction modes {28, 15, 29, 1, 30, 16, 31, 8, 32, 17, 33, 9} can correspond to the reference sample 1155. Prediction of the second PU 1145 may be performed using a sample of the reconstructed first PU 1140.

Referring to FIG. 11(C), the first PU 1175 of the current block 1170 may be predicted on the basis of a reference sample capable of obtaining high compression efficiency. The example of FIG. 11(C) illustrates a case in which one of the DC mode and planar mode as a prediction mode, distinguished from the examples of FIGS. 11(A) and 11(B). Specifically, if an above/above-left sample 1190-1 and a left/above-left sample 1190-2 are reference samples that can obtain the highest compression efficiency for the first PU 1175, the first PU 1175 can be predicted using the reference samples 1190-1 and 1190-2. For example, prediction modes {2, 34, 4, 19, 10, 18, 3, 26, 14, 27, 7} can correspond to the reference samples 1190-1 and 1190-2. Prediction of the second PU 1180 may be performed using a sample of the reconstructed first PU 1175.

In FIGS. 11(A), 11(B) and 11(C), T1, T2, T3 and T4 in units 1125, 1160 and 1195 corresponding to the current blocks represent TUs, and a transform/reconstruction sequence of the TUs may be T1→T2→T3→T4 or T1→T3→T2→T4 according to prediction sequence. Accordingly, TU T4 corresponding to the second PUs may be processed last. In the examples of FIG. 11, the TUs T1, T2, T3 and T4 are split into squares as seen from TU splitting (partitioning) structures 1125, 1160 and 1195.

While it is assumed that the aforementioned reference samples as shown in FIGS. 11(A), (B) and (C) are most effective reference samples, this is a supposition for convenience and description and most effective reference samples may depend on prediction block.

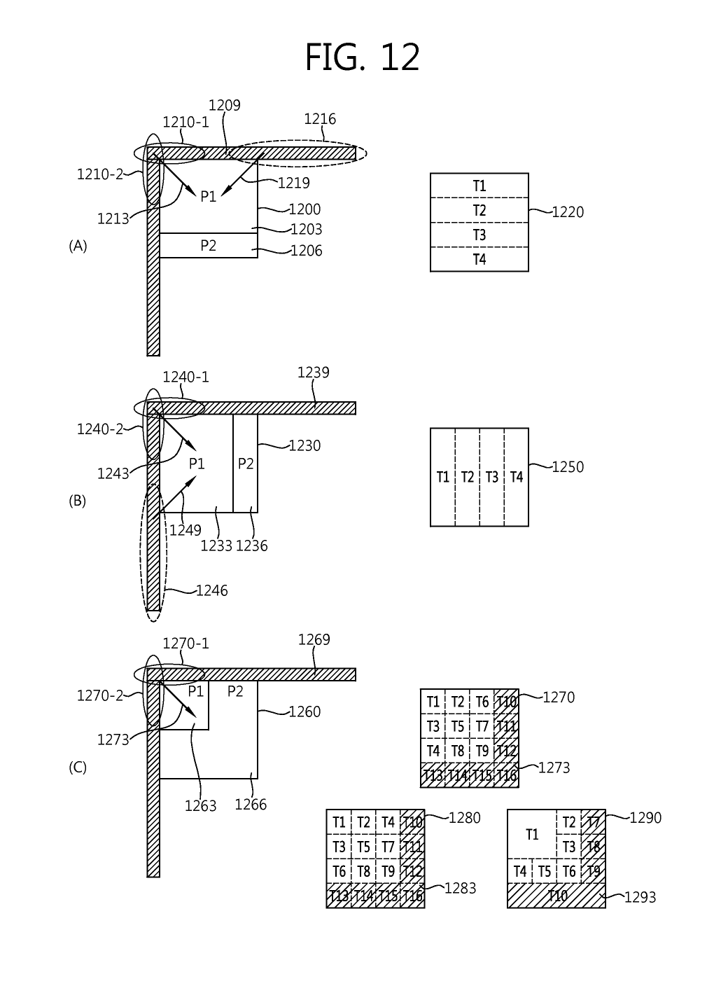

FIG. 12 illustrates other examples of partitioning the current block (target coding block) into two PUs according to prediction mode in the system to which the present invention is applied. In FIG. 12, a CU is partitioned into non-square PUs.

In FIGS. 12(A), (B) and (C), first PUs P1 obtained by partitioning CUs 1200, 1230 and 1260 may be intra-predicted on the basis of decoded samples 1209, 1239 and 1269 adjacent thereto. Coding of partitioned PUs may be performed in such a manner that prediction/reconstruction of the first PUs P1 is performed and then prediction/reconstruction of second PUs P2 is carried out. Accordingly, when the second PUs P2 having a lot of residual signals are predicted, prediction efficiency can be improved by using samples of the reconstructed first PUs P1 as reference samples.

In the example shown in FIG. 12(A), if an above/above-left sample 1210-1 or a left/above-left sample 1210-2 of the current block 1200 is a reference sample that can obtain the highest compression efficiency for the first PU 1203, the first PU 1203 can be predicted through a prediction mode 1213 using the reference sample 1210-1 or 1210-2. A case of using the reference sample 1210-1 or 1210-2 includes a case of using one of the DC mode and planar mode. If an above/above-right sample 1216 of the current block is a reference sample that can obtain the highest compression efficiency for the first PU 1203, the first PU 1203 can be predicted through a prediction mode 1219 using the reference sample 1216. Prediction of a second PU 1206 may be performed using a sample of the reconstructed first PU 1203.

In the example shown in FIG. 12(B), if an above/above-left sample 1240-1 or a left/above-left sample 1240-2 of the current block 1230 is a reference sample that can obtain the highest compression efficiency for the first PU 1233, the first PU 1233 can be predicted through a prediction mode 1243 using the reference sample 1240-1 or 1240-2. A case of using the reference sample 1240-1 or 1240-2 includes a case of using one of the DC mode and planar mode. If a left/below-left sample 1246 of the current block is a reference sample that can obtain the highest compression efficiency for the first PU 1233, the first PU 1233 can be predicted through a prediction mode 1249 using the reference sample 1246. Prediction of a second PU 1236 may be performed using a sample of the reconstructed first PU 1233.

Since prediction modes 1213 and 1273 using the above/above-left reference samples 1210-1 and 1240-1 and the left/above-left reference samples 1210-2 and 1240-2 are applicable to both the cases of FIGS. 12(A) and (B), when an intra prediction mode corresponds to the prediction modes 1213 and 1243, it is possible to signal which one of the partitioning structures shown in FIGS. 12(A) and 12(B) is used for the intra prediction mode using an indicator.

FIG. 12(C) shows an example of using a partitioning structure different from the examples of FIGS. 12(A) and 12(B), for prediction modes using an above/above-left or left/above-left reference sample. In the example shown in FIG. 12(C), if an above/above-left sample 1270-1 or a left/above-left sample 1270-2 of the current block 1260 is a reference sample that can obtain the highest compression efficiency for the first PU 1263, the first PU 1263 can be predicted through a prediction mode 1273 using the reference sample 1270-1 or 1270-2. A case of using the reference sample 1270-1 or 1270-2 includes a case of using one of the DC mode and planar mode. Prediction of a second PU 1266 may be performed using a sample of the reconstructed first PU 1263.

In FIGS. 12(A) and 12(B), T1, T2, T3 and T4 in units 1220 and 1250 corresponding to the current blocks 1200 and 1230 represent TUs, and a transform/reconstruction sequence may be T1→T2→T3→T4. Accordingly, TU T4 corresponding to the second PUs may be processed last.

In FIG. 12(C), units 1270, 1280 and 1290 correspond to the current block 1260, which show various exemplary TU splitting structures and transform sequences. T1 to T16 of the units 1270 and 1280 and T1 to T10 of the unit 1290 respectively represent TUs. T1 to T9 may be transformed/reconstructed prior to T10 all the time. In this case, it is preferable to reconstruct TUs adjacent to the above and left of a target TU in order to use a closer reconstructed sample as a reference sample.

The unit 1270 may be an example of transform/reconstruction of the TUs T1 to T9 corresponding to the first PU P1 in zigzag order. The unit 1280 may be an example of transform/reconstruction of the TUs T1 to T9 corresponding to the first PU P1 in a diagonal direction from the left-above corner to the right-below corner. The unit 1290 shows an example of combining a plurality of TUs belonging to the same PU into a single TU and processing the single TU. Comparing the unit 1290 with the units 1270 and 1280, 4 left-above TUs of the units 1270 and 1280 are processed as one TU and 4 below TUs of the units 1270 and 1280 are processed as one TU.

Referring to FIG. 12, the CU may be split into the TUs T1 to T4 in a non-square form, as seen from the TU splitting structures 1220 and 1250 shown in FIGS. 12(A) and 12(B) and the TU splitting structures 1270, 1280 and 1290 shown in FIG. 12(C).

While it is assumed that the aforementioned reference samples as shown in FIGS. 12(A), 12(B) and 12(C) are most effective reference samples, this is a supposition for convenience of description and most effective reference samples may depend on prediction block.

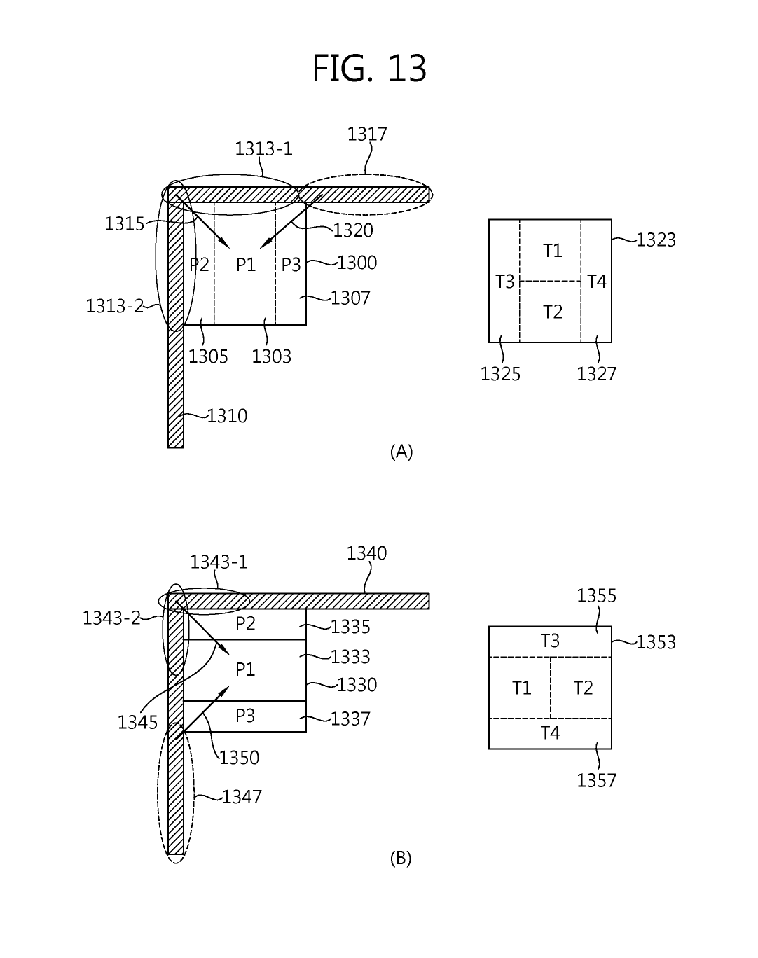

FIG. 13 illustrates examples of partitioning the current block (target coding block) into three PUs according to intra prediction mode in the system to which the present invention is applied. For example, FIG. 13 shows cases in which the current block into a square PU and a non-square PU.

Referring to FIGS. 13(A) and 13(B), first PUs P1 obtained by partitioning CUs 1300 and 1330 may be intra-predicted on the basis of decoded samples 1310 and 1340 located around the first PUs P1. Coding of partitioned PUs may be performed in such a manner that prediction/reconstruction of the first PUs P1 is performed and then prediction/reconstruction of second and third PUs P2 and P3 is carried out. Accordingly, when the second and third PUs P2 and P3 having a lot of residual signals are predicted, prediction efficiency can be improved by using samples of the reconstructed first PUs P1 as reference samples. In processing of the second and third PUs P2 and P3, the second PU P2 may be processed first or the third PU P3 may be processed first.

In the example shown in FIG. 13(A), if an above/above-left sample 1313-1 or a left/above-left sample 1313-2 of the current block 1300 is a reference sample that can obtain the highest compression efficiency for the first PU 1303, the first PU 1303 can be predicted through a prediction mode 1315 using the reference sample 1313-1 or 1313-2. A case of using the reference sample 1313-1 or 1313-2 includes a case of using one of the DC mode and planar mode. If an above/above-right sample 1317 of the current block is a reference sample that can obtain the highest compression efficiency for the first PU 1303, the first PU 1303 can be predicted through a prediction mode 1320 using the reference sample 1317. Prediction of second and third PUs 1305 and 1307 may be performed using a sample of the reconstructed first PU 1303.

In the example shown in FIG. 13(B), if an above/above-left sample 1343-1 or a left/above-left sample 1343-2 of the current block 1330 is a reference sample that can obtain the highest compression efficiency for the first PU 1333, the first PU 1333 can be predicted through a prediction mode 1345 using the reference sample 1343-1 or 1343-2. A case of using the reference sample 1343-1 or 1343-2 includes a case of using one of the DC mode and planar mode. If a left/below-left sample 1347 of the current block 1330 is a reference sample that can obtain the highest compression efficiency for the first PU 1333, the first PU 1333 can be predicted through a prediction mode 1350 using the reference sample 1347. Prediction of second and third PUs 1335 and 1337 may be performed using a sample of the reconstructed first PU 1333.

In FIGS. 13(A) and 13(B), T1, T2, T3 and T4 in units 1323 and 1353 corresponding to the current blocks 1300 and 1330 represent TUs, and a transform/reconstruction sequence may be T1→T2→T3→T4 or T1→T2→T4→T3. Accordingly, TUs T3 and T4 respectively corresponding to the second and third PUs may be processed last. Referring to FIG. 13, the CU is partitioned into mixed forms of a square and a non-square, as seen from the TU splitting structures 1323 and 1353 shown in FIGS. 13(A) and 13(B).

While it is assumed that the aforementioned reference samples as illustrated in FIGS. 13(A) and 13(B) are most effective reference samples, this is a supposition for convenience of description and most effective reference samples may depend on prediction block.

The embodiments described with reference to FIGS. 11 to 13 may be independently used, only part of the procedure of each embodiment may be used, or all or part of each embodiment may be combined with all or parts of other embodiments. For example, the embodiments shown in FIGS. 13(A) and 13(B) can be combined with the embodiment shown n FIG. 12(C). Here, if a case in which one prediction mode can have multiple block partitioning structures is generated, an additional indicator may be used to indicate which one of the multiple block segmentation structures corresponds to the prediction mode.

For a non-square TU, non-square transform, for example, rectangular transform may be applied, or signal values, that is, residual signals may be reordered in a square form and then square transform may be applied thereto.

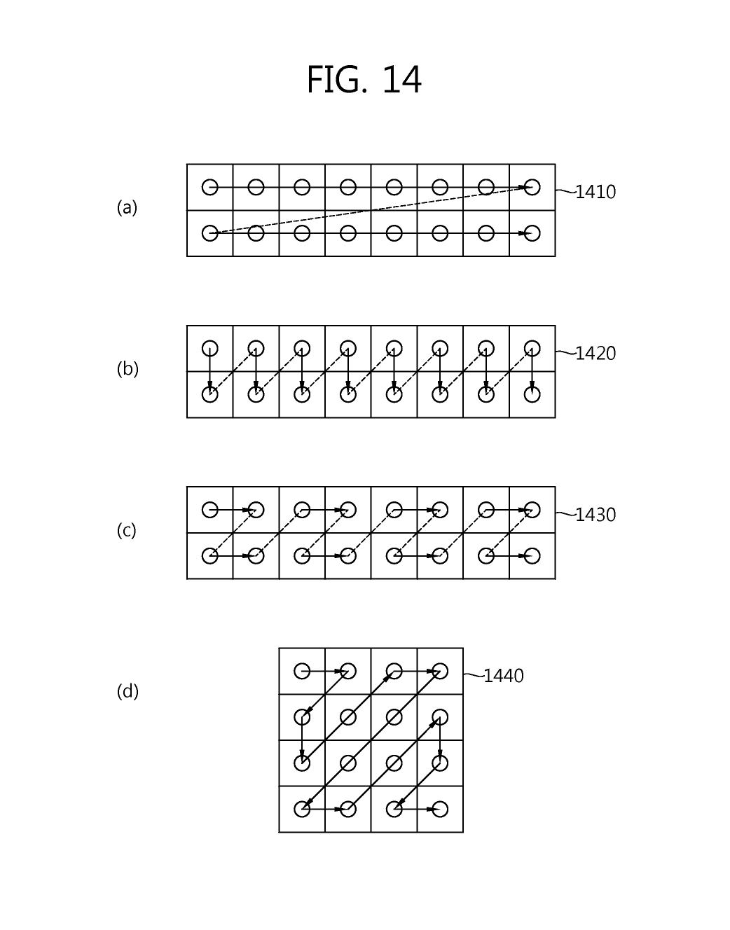

FIG. 14 illustrates examples of transform of a non-square TU in the system to which the present invention is applied. FIG. 14 illustrates a signal value reordering procedure for an 8×2 non-square TU in an encoder.

FIG. 14(A) shows an example of horizontal scanning of residual signal values of the 8×2 non-square TU. FIG. 14(B) shows an example of vertical scanning of the residual signal values of the 8×2 non-square TU. FIG. 14(C) shows an example of zigzag scanning of the residual signal values of the 8×2 non-square TU.

The scanning schemes shown in FIGS. 14(A), 14(B) and 14(C) may be predetermined according to a prediction mode of a first PU in a CU.

The signal values of the TU, scanned as illustrated in FIGS. 14(A), 14(B) and 14(C), may be reordered in a square TU. For example, the signal values in the 8×2 non-square TU can be reordered in a 4×4 square TU as shown in FIG. 14(D). The reordered signal values can be transformed into a frequency domain according to a transform scheme such as discrete cosine transform (DCT) and/or discrete sine transform (DST).

A decoder inversely transforms transform coefficients ordered in the square TU. Inverse transform may be performed in such a manner that a transform scheme used to generate the transform coefficients is inversely applied. For example, inverse discrete cosine transform (IDCT) and/or inverse discrete sine transform (IDST) can be applied to the transform coefficients. The decoder may scan the inversely transformed transform coefficients in a reverse direction of the scanning direction of FIG. 14(D) and reorder the transform coefficients in a reverse direction of the scanning direction of FIG. 14(A), 14(B) or 14(C) to thereby reorder the inversely transformed transform coefficients in an 8×2 non-square TU.

When a target coding block (current block) is partitioned into two or more PUs, a prediction mode of a PU predicted first and a prediction mode of a PU predicted later may have high correlation. By using this characteristic, it is possible to reduce overhead of signaling necessary for coding of prediction modes of PUs and to improve coding performance.

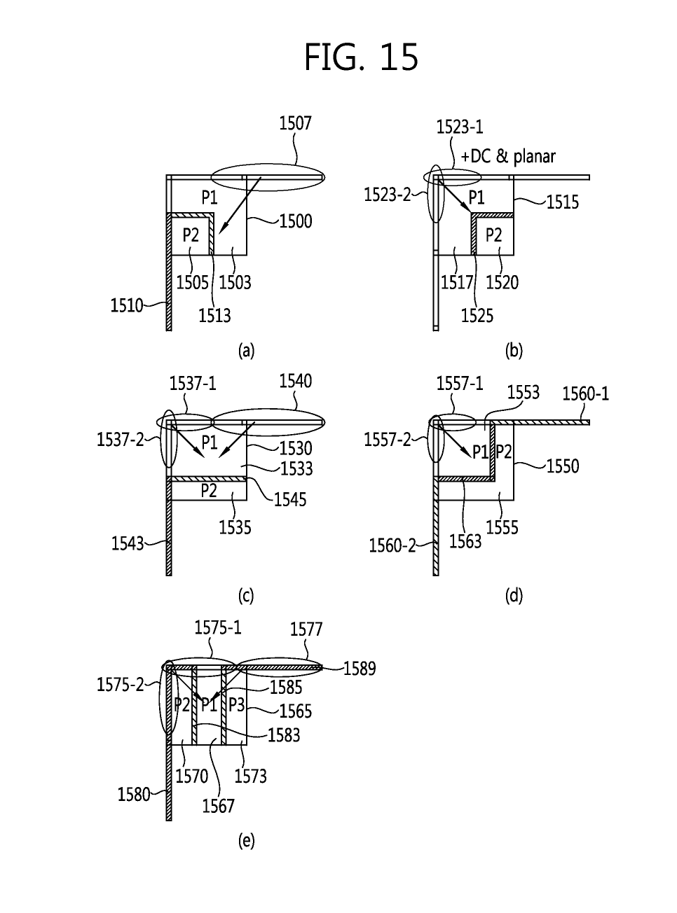

FIG. 15 illustrates examples of predicting a lower priority PU using a reconstructed sample of a higher priority PU on the basis of correlation between the lower priority PU and the higher priority PU in a current block in the system to which the present invention is applied.

In the example of FIG. 15(A), a first PU 1503 of a current block 1500 is predicted using an above/above-right reference sample 1507. A second PU 1505 may be predicted using a left/below-left reference sample 1510 and/or a sample 1513 of the reconstructed first PU 1503. Here, the sample 1513 of the first PU 1503, which is used to predict the second PU 1505, is adjacent to the second PU 1505 and is reconstructed before the second PU 1505 is predicted.

In the example of FIG. 15(B), a first PU 1517 of a current block 1515 is predicted using an above/above-left reference sample 1523-1 or a left/above-left sample 1523-2. A second PU 1520 of the current block 1515 may be predicted using a sample 1525 of the reconstructed first PU 1517. Here, the sample 1525 of the first PU 1517, which is used to predict the second PU 1520, is adjacent to the second PU 1520 and is reconstructed before the second PU 1520 is predicted.

In the example of FIG. 15(C), a first PU 1533 of a current block 1530 may be predicted using an above/above-left reference sample 1537-1 or a left/above-left sample 1537-2. Otherwise, the first PU 1533 may be predicted using an above/right-above reference sample 1540. A second PU 1535 of the current block 1530 may be predicted using a left/below-left reference sample 1543 and/or a sample 1545 of the reconstructed first PU 1533. Here, the sample 1545 of the first PU 1533, which is used to predict the second PU 1535, is adjacent to the second PU 1535 and is reconstructed before the second PU 1535 is predicted.

In the example of FIG. 15(D), a first PU 1553 of a current block 1550 may be predicted using an above/above-left reference sample 1557-1 or a left/above-left sample 1557-2. A second PU 1555 of the current block 1550 may be predicted using an above/above-right reference sample 1560-1, a left/below-left reference sample 1560-2 and/or a sample 1563 of the reconstructed first PU 1553. Here, the sample 1563 of the first PU 1553, which is used to predict the second PU 1555, is adjacent to the second PU 1555 and is reconstructed before the second PU 1555 is predicted.

In the example of FIG. 15(E), a first PU 1567 of a current block 1565 may be predicted using an above/above-left reference sample 1575-1 or a left/above-left sample 1575-2. Otherwise, the first PU 1567 may be predicted using an above/right-above reference sample 1577. A second PU 1570 of the current block 1565 may be predicted using a left/below-left reference sample 1580 and an above/above-left reference sample 1575-1 and/or a sample 1583 of the reconstructed first PU 1567. In addition, a third PU 1573 of the current block 1565 may be predicted using an above/above-right reference sample 1589 and/or a sample 1585 of the first PU 1567. Here, the samples 1583 and 1585 of the first PU 1567, which are used to predict the second PU 1570 and the third PU 1573, are respectively adjacent to the second PU 1570 and the third PU 1573 and are reconstructed before the second PU 1570 and the third PU 1573 are predicted.

Referring to FIG. 15, since the second PUs P2 in FIGS. 15(A) to 15(D) and the second and third PUs P2 and P3 in FIG. 15(E) are closer to the first PUs P1 than other reconstructed samples, prediction mode candidates for the second and third PUs P2 and P3 may be limited to prediction modes (prediction modes using reference samples 1507, 1523-1, 2523-2, 1537-1, 1537-2, 1540, 1557-1, 1557-2, 1575-1, 1575-2, 1577, etc.) available for prediction of the first PUs P1.

Alternatively, the prediction mode candidates for the second and third PUs P2 and P3 may be limited to prediction modes used to predict regions adjacent to the second and third PUs P2 and P3 shown in FIGS. 15(A) to 15(E).

Furthermore, the above two examples are combined to limit the prediction mode candidates for the second and third PUs P2 and P3 to the prediction modes (prediction modes using reference samples 1507, 1523-1, 2523-2, 1537-1, 1537-2, 1540, 1557-1, 1557-2, 1575-1, 1575-2, 1577, etc.) available for prediction of the first PUs P1 and prediction modes of regions adjacent to the second PUs P2 or third PUs P3 from among units other than the first PUs P1.

As illustrated in FIG. 15, the shape and range of a sample that can be used to predict a PU depend on the shape and position of the PU. When reference samples surround a PU, for example, the second PU P2 shown in FIGS. 15(A) and 15(E), prediction efficiency can be improved by predicting the PU using bidirectional prediction, for example, using a weighted sum of prediction values.

It is possible to set candidate prediction modes for PUs according to the methods illustrated in FIG. 15 and the encoder can select one of the candidate prediction modes and predict the a PU using the selected prediction mode. A prediction mode may be determined in consideration of compression efficiency such as rate distortion optimization (RDO). The encoder may transmit information about the selected prediction mode to the decoder.

The decoder may set candidate prediction modes using the same method as that used by the encoder and select a prediction mode to be applied to a current PU, or apply a prediction mode designated by information transmitted from the encoder to a current prediction block.

While reference samples (prediction modes) for PUs are selected as illustrated in FIG. 15, this is exemplary and the reference samples (prediction modes) can be selected in various manners according to characteristics of the PUs.

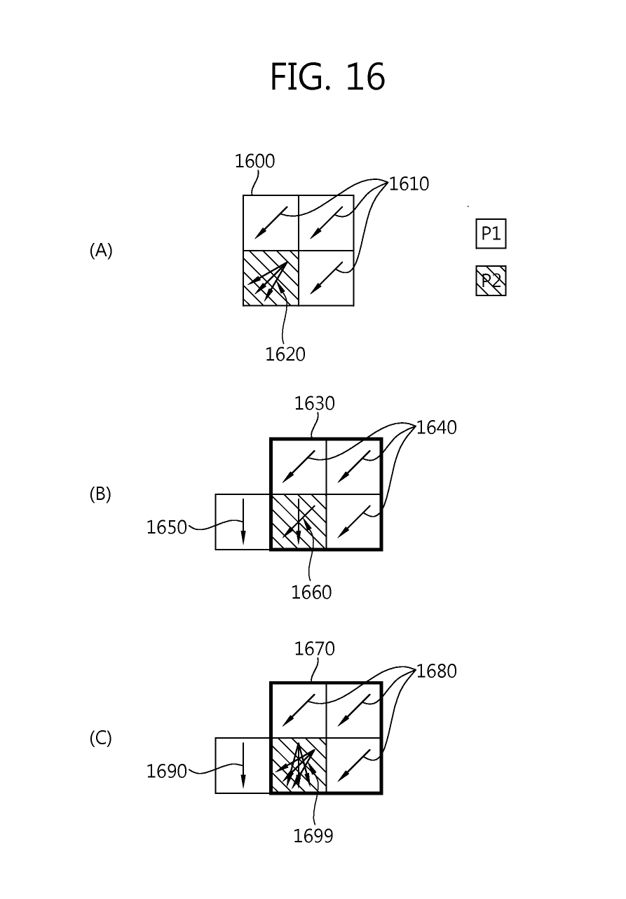

FIG. 16 illustrates examples of determining a prediction mode of a current PU in the system to which the present invention is applied.

FIG. 16(A) illustrates an example of using a prediction mode 1610 of a first PU P1 in a current block 1600 as a prediction mode 1620 of a second PU P2 in the current block 1600. In this case, it may be possible to use a prediction mode having an angle similar to the prediction mode 1610 of the first PU P1 as the prediction mode of the second PU 1620 rather than using the prediction mode 1610 of the first PU P1 as the prediction mode of the second PU P2. If the prediction mode of the first PU P1 is a DC mode or a planar mode, the DC mode or planar mode can be used as the prediction mode of the second PU P2.

FIG. 16(B) illustrates an example of using a prediction mode of a block adjacent to the second PU P2 as a prediction mode 1660 of the second PU P2 for the first PU P1 and the second PU P2 in a current block 1630. For example, a prediction mode 1650 of a block located at the left of the second PU P2 or a prediction mode 1640 of the first PU P1 adjacent to the second PU P2 can be used as the prediction mode 1660 of the second PU P2.

FIG. 16(C) illustrates an example of combination of the examples of FIGS. 16(A) and 16(B). Referring to FIG. 16(C), a prediction mode 1699 of the second PU P2 may be determined from prediction modes 1680 and 1690 of blocks adjacent to the second PU P2 and prediction modes similar to the prediction modes 1680 and 1690.

As described in the examples of FIG. 16, the encoder can select a prediction mode to be applied to a current PU. When a prediction mode is selected from candidates including prediction modes having angles similar to prediction modes of neighboring blocks (including the first PU), the prediction mode to be applied to the current PU can be determined in consideration of compression efficiency such as RDO. The encoder may transmit information about the selected prediction mode to the decoder.

The decoder may set candidate prediction modes using the same method as that used by the encoder and then select a prediction mode to be applied to the current PU. Accordingly, prediction modes which will be applied to PUs (third PU, fourth PU, . . . ) following the second PU may be predetermined between the encoder and the decoder according to the prediction mode and/or PU partitioning structure for the first PU. Furthermore, the decoder may apply a prediction mode indicated by information transmitted from the encoder to the current prediction block.

While the methods have been described as steps or blocks on the basis of flowcharts in the above-described exemplary system, the present invention is not limited to the order of steps and some steps may be generated differently from the above steps or simultaneously. Furthermore, the above-mentioned embodiments include various illustrations of various aspects. Accordingly, the present invention may comprise all alternatives, modifications and variations belonging to the claims. When it is said that one component is “connected” or “coupled” to another component in the above description, one component may be directly connected or coupled to the other component but it may be understood that another component may be present between the two components. When it is said that one component is “directly connected” or “directly coupled” to another component, it should be understood that another component does not exist between the two components.

1. A method for decoding video information, the method comprising:
partitioning a prediction unit (PU) into a first PU and a second PU according to an intra prediction mode;
performing intra prediction and reconstruction of the first PU; and
performing prediction and reconstruction of the second PU,
wherein, in the prediction and reconstruction of the second PU, intra prediction of the second PU is performed with reference to a reference sample for the first PU or a predetermined sample in the reconstructed first PU.

2. The method of claim 1, wherein information about the intra prediction mode is received from an encoder and, in the partitioning of the PU, a region in which a residual signal that exceeds a reference value is present is set as the second PU when the intra prediction mode is used.

3. The method of claim 1, wherein information about the intra prediction mode is received from an encoder and the second PU is the farthest block in a current block from a reference sample of the intra prediction mode.

4. The method of claim 1, wherein information about the intra prediction mode is received from an encoder, and the first PU and the second PU are predetermined for each intra prediction mode.

5. The method of claim 1, wherein the performing of intra prediction and reconstruction of the second PU comprises generating a residual signal on the basis of a transform coefficient of a transform unit (TU) corresponding to the second PU and combining a prediction result with respect to the second PU with the generated residual signal to generate a reconstructed signal.

6. The method of claim 1, wherein the second PU is further partitioned into a plurality of PUs, and the plurality of PUs are intra-predicted with reference to the reference sample for the first PU or predetermined samples in other reconstructed PUs.

7. The method of claim 1, wherein a prediction mode applied to the second PU is selected from a prediction mode applied to the first PU and prediction modes having angles similar to the prediction mode applied to the first PU.

8. The method of claim 7, wherein intra prediction of the second PU is performed with reference to a sample in the reconstructed first PU.

9. The method of claim 1, wherein a prediction mode applied to the second PU is selected from candidate prediction modes for the first PU.

10. The method of claim 1, wherein a prediction mode applied to the second PU is selected from a prediction mode applied to a block adjacent to the second PU and prediction modes having angles similar to the prediction mode applied to the block adjacent to the second PU.

11. A method for encoding video information, the method comprising:
partitioning a prediction unit (PU) into a first PU and a second PU according to an intra prediction mode;
performing intra prediction and reconstruction of the first PU;
performing prediction and reconstruction of the second PU; and
transmitting information about a prediction mode of a current block,
wherein, in the prediction and reconstruction of the second PU, intra prediction of the second PU is performed with reference to a reference sample for the first PU or a predetermined sample in the reconstructed first PU.

12. The method of claim 11, wherein in the partitioning of the PU, a region in which a residual signal that exceeds a reference value is present is set as the second PU when the intra prediction mode is used.

13. The method of claim 11, wherein the second PU is the farthest block in the current block from a reference sample of the intra prediction mode.

14. The method of claim 11, wherein the performing of intra prediction and reconstruction of the second PU comprises generating a residual signal on the basis of a transform coefficient of a TU corresponding to the second PU and combining a prediction result with respect to the second PU with the generated residual signal to generate a reconstructed signal.

15. The method of claim 14, wherein the TU is a block having the same size as the first PU and the second PU or a square or a non-square block obtained by partitioning the first PU or the second PU.

16. The method of claim 11, wherein in the partitioning of the PU into the first PU and the second PU, the second PU is further partitioned into a plurality of PUs, and intra prediction of the plurality of PUs is performed with reference to the reference sample for the first PU or predetermined samples in other reconstructed PUs.

17. The method of claim 11, wherein a prediction mode applied to the second PU is selected from a prediction mode applied to the first PU and prediction modes having angles similar to the prediction mode applied to the first PU.

18. The method of claim 11, wherein a prediction mode applied to the second PU is selected from a prediction mode of a block adjacent to the second PU and prediction modes having angles similar to the prediction mode of the block adjacent to the second PU.
